(19) United States
(12) Patent Application Publication
(10) Pub. No.: US 2005/0123823 A1
(43) Pub. Date: Jun. 9, 2005

(54) Enzyme-based photoelectrochemical cell for electric current generation

(76) Inventors: John Devens Gust Jr., Mesa, AZ (US); Thomas Andrew Moore, Scottsdale, AZ (US); Ana Lorenzelli Moore, Scottsdale, AZ (US); Linda Deyanira de la Garza, Tempe, AZ (US)

Correspondence Address: Quarles & Brady Streich Lang, One Renaissance Square, Two North Central Avenue, Phoenix, AZ, 85004, US

(21) Appl. No.: 10/507,663

(22) PCT Filed: Apr. 16, 2002
(86) PCT No.: PCT/US02/11831

Related U.S. Application Data
(60) Provisional application No. 60/364,879, filed on Mar. 14, 2002.

(51) Int. Cl. H01M 4/90; H01M 8/00

(52) U.S. Cl. 429/43; 429/13

(57) ABSTRACT

The invention provides a photobiological fuel cell converting chemical energy possessed by a carbon-containing compound and light energy into electrical energy. A positive electrode (24) and a negative electrode (23) provided with an electrolyte (26) interposed between them are arranged as constituents. An electromotive force is generated across the positive electrode (24) and the negative electrode (23) by an oxidation reaction involving an electrochemical reception of electrons from carbon-containing compound by an external electric circuit via the intermediacy of a photosensitizer molecule excited by light, an oxidation-reduction mediator, catalytic enzymes, and reduction reactions at a positive electrodes (24).

### FIELD OF THE INVENTION

The present invention relates to a photobiological fuel cell utilizing a photoelectrochemical reaction and an enzymatic action which in combination perform generation of electricity by the action of a photosensitizer compound which produces an oxidant species and an electron when irradiated with light, an oxidation-reduction mediator which supplies an electron to the oxidant species, and one or more enzymes that oxidize a carbon-containing compound and reduce the oxidation-reduction mediator to return it to its original form. The carbon-containing compound may be one that is cyclically regenerated in a natural biosphere, such as carbohydrate (e.g., sugar, starch), lipid, hydrocarbon, alcohol, aldehyde or organic acid.

### BACKGROUND OF THE INVENTION

A carbon-containing compound which is cyclically regenerated in a natural biosphere such as carbohydrate (e.g., sugar, starch), lipid, hydrocarbon, alcohol, aldehyde or organic acid is produced from carbon dioxide gas and water by photosynthesis. Solar energy, which has been converted to chemical energy and accumulated in the form of carbon-containing compounds, is used as chemical energy in the metabolism of an organism to produce carbon dioxide gas and water. This forms a clean cyclic system. For example, a carbohydrate, which is a general term for saccharides such as monosaccharide, oligosaccharide and polysaccharide as well as saccharide analogues such as cyclic polyvalent alcohols and amino saccharides, is made by a plant or other photosynthetic organism during photosynthesis. A second organism can ingest a carbohydrate from a plant and use it as a food to provide energy. When glucose, which is a typical carbohydrate represented by the chemical formula C₆H₁₂O₆, is completely oxidized, it releases 24 electrons per molecule, and is converted to carbon dioxide gas. In the body of an animal or other organism, the potential energy of the 24 electrons is utilized as an energy source. A thermodynamic calculation shows that glucose has a potentially useable energy of 2,872 kJ per mol, or 4.43 Wh per g. This energy density exceeds the weight energy density (3.8 Wh/g) of metallic lithium, which is used as a negative electrode for a lithium battery, which is known as a high energy density battery.

There are several methods for utilizing the chemical energy possessed by a carbon-containing compound such as a carbohydrate. One such method comprises direct combustion of a carbon-containing compound in air to give heat energy. Another method uses a carbon-containing compound as a nutrient in fermentation, wherein a microorganism produces fuels such as methane or ethanol. Yet another method produces an energy-rich compound such as ATP through the mediation of enzymes present in an organism.

As one method for utilizing the chemical energy possessed by a carbon-containing compound, there is a biological fuel cell disclosed in U.S. Pat. No. 6,294,281 that uses an enzyme and an oxidation-reduction mediator. Further, U.S. Pat. No. 4,117,202 discloses a photosynthetically driven biological fuel cell, which generates electricity using a photosynthetic cell derived from a living organism (Digitaria sanguinalis) that uses a carbon-containing compound as a nutrient.

The photosynthetically driven biological fuel cell disclosed in U.S. Pat. No. 4,117,202 can utilize chemical energy possessed by a carbon-containing compound as well as light radiation energy such as sunlight. This may be an improvement compared with the process disclosed in U.S. Pat. No. 6,294,281, which can utilize only chemical energy possessed by a carbon-containing compound. However, the photosynthetically-driven biological fuel cell disclosed in U.S. Pat. No. 4,117,202 utilizes a photosynthetic cell originated from a living organism, and thus requires careful control over temperature, solution formulation, and nutrient to allow the living cells to survive. This fuel cell is also disadvantageous in that a culture vessel for living cells must be used, requiring a complicated and large power-generating apparatus. The biological fuel cell disclosed in U.S. Pat. No. 6,294,281 can generate electric power merely by dipping positive and negative electrodes having an enzyme and an oxidation-reduction mediator fixed thereto into an electrolyte containing a carbon-containing compound. Thus, this biological fuel cell is advantageous in that it requires only a simplified power-generating system and can be miniaturized. However, this biological fuel cell cannot utilize light radiation energy.

### SUMMARY OF THE INVENTION

It is therefore an aim of the invention to provide a photobiological fuel cell which can be miniaturized and utilize light energy in addition to chemical energy possessed by a carbon-containing compound.

The foregoing aim of the present invention will become apparent from the following detailed description and examples.

The invention provides a photobiological fuel cell comprising a positive electrode and a negative electrode provided with an electrolyte interposed between them. Through the action of several intermediary species, the negative electrode receives an electron from a carbon-containing fuel compound, which is therefore oxidized. The carbon-containing fuel compound may be one that is cyclically regenerated in a natural biosphere, such as carbohydrate (e.g., sugar, starch), lipid, hydrocarbon, alcohol, aldehyde or organic acid. This oxidation is accomplished through several mediators. The first of these is a photosensitizer material, attached to the negative electrode, that is converted to an electronically excited state when irradiated with light. The electronically excited state injects an electron into the electrode, from where it flows into an external circuit to do work. Loss of an electron from the photosensitizer material leaves an oxidized photosensitizer, which is in turn reduced back to its original form by an oxidation-reduction mediator. The resulting oxidized form of the oxidation-reduction mediator is reduced back to its original form by one or more enzymes, which obtain the necessary electrons by oxidation of the carbon-containing fuel compound. Thereby, chemical energy possessed by the carbon-containing fuel compound and light energy such as sunlight can be utilized to generate electricity.

The positive electrode may be one that undergoes an oxygen reduction reaction at a higher potential (i.e., more anodic potential) than the oxidation reaction at the negative electrode, or another suitable electrode.

### BRIEF DESCRIPTION OF THE DRAWINGS

By way of example and to make the description more clear, reference is made to the accompanying drawings in which:

FIG. 1 is a schematic diagram illustrating the procedure of photoelectrochemical oxidation of a carbon-containing compound (fuel) by a photosensitizer (S) in the presence of an enzyme and an oxidation-reduction mediator (R) of the invention;

FIG. 2 is a diagram illustrating the structure of a power-generating cell used in the evaluation of the photoelectrochemical properties and battery properties in an example of the invention, wherein the reference numeral 21 indicates a power-generating cell, the reference numeral 22 indicates a silicon plug, the reference numeral 23 indicates a negative electrode, the reference numeral 24 indicates a counter electrode, the reference numeral 25 indicates a reference electrode, the reference numeral 26 indicates an electrolyte, and the reference numeral 27 indicates an air electrode;

FIG. 3 is a diagram illustrating the current-voltage characteristics of the power-generating cell in another example of the invention;

FIG. 4 is a diagram illustrating the change of NADH concentration with time a solution containing various combinations of enzymes and methanol;

FIG. 5 is a diagram illustrating the relationship between the amount of NADH consumed in the electrolyte in the power-generating cell and the amount of electrons removed from the power-generating cell by the external circuit in a further example of the invention;

FIG. 6 is a diagram illustrating the relationship between the consumed amount of NADPH in the electrolyte in the power-generating cell and the amount of electrons removed from the power-generating cell by the external circuit in a further example of the invention;

FIG. 7A is a diagram illustrating the change of NADH concentration with time in the electrolyte in the power-generating cell in a further example of the invention;

FIG. 7B is a diagram illustrating the change of NADH concentration with time in the electrolyte in the power-generating cell in a further example of the invention; and

FIG. 8 is a diagram illustrating the relationship between the amount of NADH consumed in the electrolyte in the power-generating cell and the amount of electrons taken out of the power-generating cell by the external circuit in a further example of the invention.

### DETAILED DESCRIPTION OF DRAWINGS

The photobiological fuel cell of the invention includes a positive electrode and a negative electrode provided as constituents with an electrolyte interposed between them. When the negative electrode receives electrons from a carbon-containing fuel compound via a photosensitizer compound which produces an oxidant and electrons when irradiated with light, an oxidation-reduction mediator which supplies electrons to the oxidized photosensitizer molecule, and enzymes that catalyze oxidation of the carbon-containing fuel compound, an electromotive force is generated across the positive electrode and the negative electrode. This makes it possible to utilize chemical energy accumulated in the carbon-containing compound directly as electrical energy in a form biased by light radiation energy.

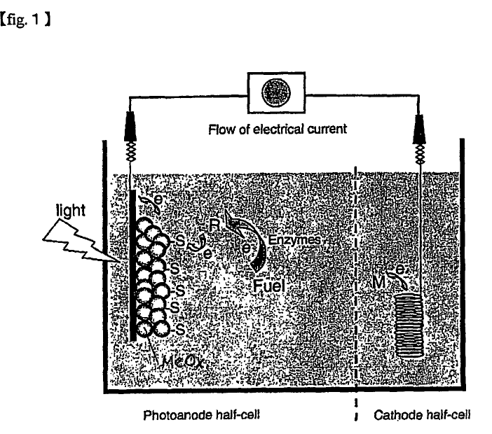

FIG. 1 illustrates a schematic diagram of the configuration of the photobiological fuel cell of the invention. FIG. 1 illustrates how electrons (e⁻) which have been possessed by a carbon-containing compound (fuel) are released from the carbon-containing compound and ultimately flow through an external electric circuit (load) from the negative electrode to the positive electrode. The electron flow within the cell occurs via a photosensitizer compound (S) retained in or on an oxide semiconductor (MeOx) shown in a spherical form. When irradiated with light, sensitizer S produces an excited state S*. The excited state S* injects an electron into the semiconductor, leaving an oxidant S⁺. The electron (e⁻) has been biased by light irradiation to the optical excitation energy of S (the difference in energy between S and S*). The electron does work in the external circuit, and reaches the positive electrode, where it is used in a reduction reaction with material M. In this manner, an electromotive force is generated across the positive electrode and the negative electrode, generating electricity. During the process, the oxidized photosensitizer S⁺ is reduced to its original form by a redox mediator R, generating R in an oxidized form. The enzyme(s) reduce the oxidized redox mediator back to its original form, obtaining the necessary electrons from oxidation of the carbon-containing fuel compounds. Thus, neither photosensitizer S nor redox mediator R are consumed.

The photosensitizer compound S, which produces an oxidant S+ and an electron when irradiated with light, is disposed on an oxide semiconductor. This compound may have a single light absorption peak or a plurality of light absorption peaks in a wavelength range of ˜300 nm to ˜1,000 nm. Such a compound may be a metal complex dye, organic dye, or the like. Examples of a metal complex dye are ruthenium complex dyes or platinum complex dyes having biquinoline, bipyridyl, phenanthroline, or thiocyanic acid or derivatives thereof as ligands. Examples of organic dyes which may also contain metal atoms are porphyrin-based dyes having a single porphyrin ring or a plurality of porphyrin rings. The porphyrin rings may be metal free, or contain zinc (Zn), magnesium (Mg), or the like as a central atom. Examples of such a porphyrin-based dye include those represented by the general formulae P1 to P6 below. Examples of organic dyes are 9-phenylxanthene-based dyes, merocyanine-based dyes, polymethine-based dyes, or the like. In particular, the compound P1, 5-(4-carboxyphenyl)-10,15,20-(4-methylphenyl) porphyrin, having the structure shown below has a high light absorption efficiency and also high affinity for the oxide semiconductor so that it cannot be easily eluted with the electrolyte and thus can be kept stable even after a prolonged contact with the electrolyte. Further, since generation of excited electrons from the compound P1 by irradiation with light can occur over a prolonged lifetime, the compound P1 can exhibit high photoelectric conversion efficiency to advantage. The disposition of a compound which produces an oxidant and an electron when irradiated with light on an oxide semiconductor makes it possible to quickly move an excited electron produced by irradiation with light to the oxide semiconductor and makes less likely the recombination of the oxidant and excited electron produced by irradiation with light, thereby keeping the efficiency of reception of electrons from the carbon-containing compound into the external electrical circuit higher.

As the oxide semiconductor, tin dioxide (SnO₂), titanium dioxide (TiO₂), zinc oxide (ZnO), tungsten oxide (WO₃) or composites thereof such as TiO₂—WO₃ may be used.

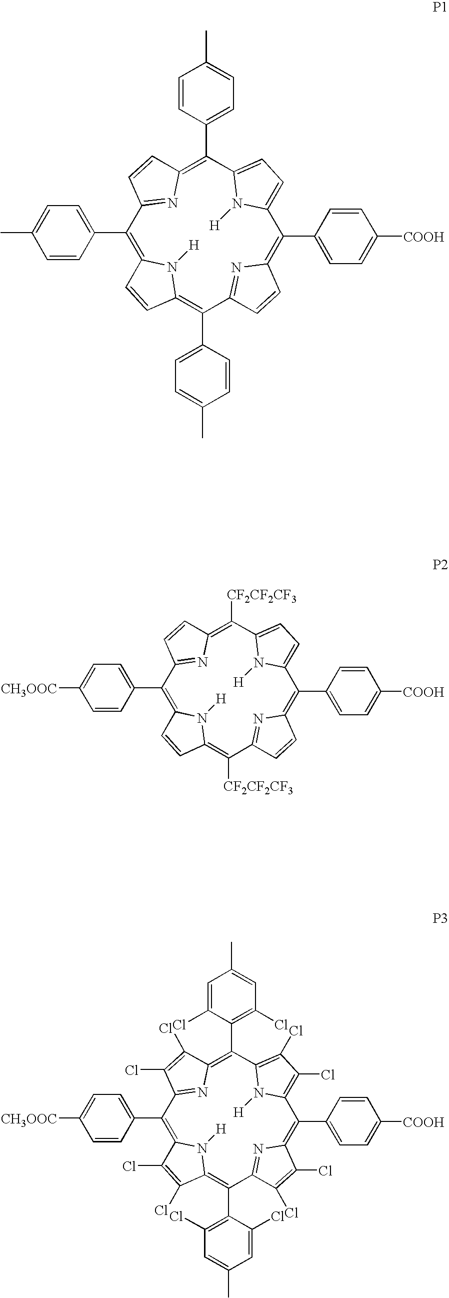

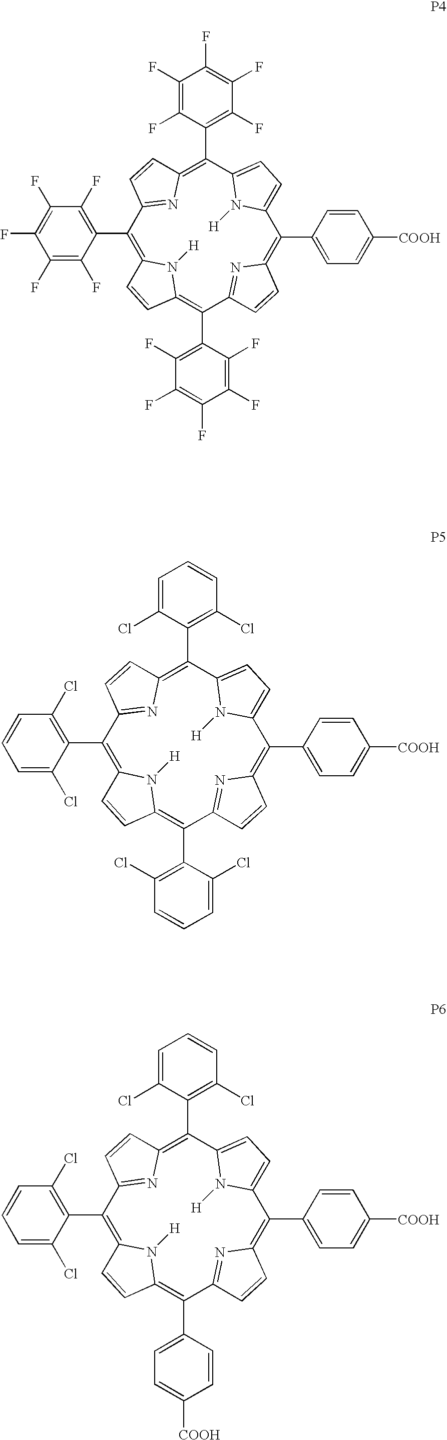

Examples of the carbon-containing fuel compound used in this invention, which may be one that is cyclically regenerated in a natural biosphere, include carbohydrates (e.g., sugars, starches), lipids, hydrocarbons, alcohols, aldehydes and organic acids. Such compounds can be produced from carbon dioxide gas and water by photosynthesis and then accumulated. The solar energy stored in these compounds is used as chemical energy via the metabolism of a organism, producing carbon dioxide gas. This forms a clean cyclic system.

Examples of the oxidation-reduction mediator (R) which receives electrons from the carbon-containing fuel compound through the mediation of enzymes and supplies electrons to the oxidant (S⁺) produced by irradiation with light to regenerate the original photosensitizer compound (S) are a quinone/hydroquinone oxidation-reduction couple, the NAD⁺/NADH oxidation-reduction couple, the NADP⁺/NADPH oxidation-reduction couple, the I₂/I₃⁻ oxidation-reduction couple, and metal proteins having an oxidation-reduction capacity such as ferredoxin and myoglobin.

The enzymes, which catalyze the transfer of electrons from the carbon-containing fuel compound to an oxidized form of the oxidation-reduction mediator R, are not specifically limited. In practice, however, dehydrogenase enzymes may be used singly or in combination depending on the kind of the carbon-containing fuel compound. In the case where the fuel is glucose, an enzyme system containing at least glucose dehydrogenase (GDH) may be used.

In the case where the fuel is D-glucose-6-phosphate, an enzyme system containing at least D-glucose-6-phosphate dehydrogenase (G-6-PDH) or at least G-6-PDH and 6-phosphogluconate dehydrogenase (6-PGDH) may be used.

In the case where the fuel is methyl alcohol, an enzyme system containing at least an alcohol dehydrogenase (ADH), an enzyme system containing at least ADH and an aldehyde dehydrogenase (ALDH), or an enzyme system containing at least ADH, ALDH and a formate dehydrogenase (FDH) may be used.

In the case where the fuel is ethyl alcohol, an enzyme system containing at least an alcohol dehydrogenase (ADH) or an enzyme system containing at least ADH and an aldehyde dehydrogenase (ALDH) may be used. In the case where a plurality of fuels is used, enzymes corresponding to these fuels may be used in admixture.

As the electrolyte to be incorporated into the photobiological fuel cell of the invention there may be used any material regardless of whether it is an organic material, inorganic material, liquid or solid so far as it allows the movement of anions and/or cations from the positive electrode to the negative electrode and/or from the negative electrode to the positive electrode to cause continuous progress of oxidation-reduction reactions at the positive electrode and the negative electrode. An aqueous solution obtained by dissolving a salt such as KCl, NaCl, MgCl₂, NH₄Cl and Na₂HPO₄, an alkali such as NH₄OH, KOH and NaOH or an acid such as H₃PO₄ and H₂SO₄ in water is safe, causes no environmental pollution, and can be easily handled to advantage. Alternatively, a solution of a quaternary ammonium salt such as pyridinium iodide, a lithium salt such as lithium iodide, an imidazolium salt such as imidazolinium iodide, t-butylpyridine or the like in acetonitrile, methoxyacetonitrile or methoxypropionitrile, an ion exchange membrane made of a polymer material such as fluororesin having sulfonic acid groups, amide groups, ammonium groups, pyridinium groups or the like or a polymer electrolyte such as solution of a salt such as LiBF₄, LiClO₄ and (C₄H₉)₄NBF₄ in a polypropylene oxide, polyethylene oxide, acrylonitrile, polyvinylidene fluoride, polyvinyl alcohol or the like may be used.

The reaction at the positive electrode in the photobiological fuel cell of the invention involves a reduction reaction occurring at a higher (or more anodic) potential than that of the electron taken out of the carbon-containing compound via an optically excited active species (S*) of molecule at the negative electrode. Any reduction reaction can be employed so far as the electron thus taken out is electrochemically received by the positive electrode via the external load.

Examples of the reaction at the positive electrode include reduction reactions of water or oxygen, reduction reactions of hydroxide or oxides such as NiOOH, MnOOH, Pb(OH)₂, PbO, MnO₂, Ag₂O, LiCoO₂, LiMn₂O₄ and LiNiO₂, reduction reactions of sulfides such as TiS₂, MoS₂, FeS and Ag₂S, reduction reactions of metal halides such as AgI, PbI₂ and CuCl₂, reduction reactions of halogen such as Br₂ and I₂, reduction reactions of organic sulfur compounds such as quinone and organic disulfide compounds, and reduction reactions of electrically-conductive polymers such as polyaniline and polythiophene.

In particular, the positive electrode is preferably an oxygen electrode for reducing oxygen. In this arrangement, a gas containing oxygen can be used as the positive active material, eliminating the necessity of retaining a positive active material in the battery and hence making it possible to form a battery having a higher energy density.

Any material capable of reducing oxygen may be used as the oxygen electrode. Examples of such an oxygen-reducing material include activated charcoal, manganese oxide including MnO₂, Mn₃O₄, Mn₂O₃ and Mn₅O₈, platinum, palladium, iridium oxide, platinum-ammine complexes, cobalt-phenylenediamine complexes, metal porphyrins (metal: cobalt, manganese, zinc, magnesium, etc.), and perovskite oxides such as La(Ca)CoO₃ and La(Sr)MnO₃.

The invention will be further described in the following examples.

### EXAMPLE 1

As a photosensitizer compound which produces an oxidant and an electron when irradiated with light, 5-(4-carboxyphenyl)-10,15,20-(4-methylphenyl)porphyrin (P1) was used as a typical representative of a porphyrin photosensitizer used to prepare a negative electrode.

### Preparation of the Negative Electrode

A light-transmitting glass substrate with a thickness of 1 mm bearing a thin film of electrically conducting indium-tin oxide (ITO) with a surface resistivity of 10-12 Ω/cm² was used to prepare the negative electrode. A 1% by weight aqueous dispersion of particulate tin dioxide (SnO₂) having an average particle diameter of 10 nm was deposited on the ITO film by spraying or otherwise applying layers over a hot plate. The electrode was dried at a temperature of 80° C., and then sintered at a temperature of 400° C. in air for 1 hour to form a film of particulate SnO₂. Subsequently, the electrode was dipped into a 1-5 mM solution of photosensitizer P1 (dissolved in dichloromethane, toluene, or hexanes) for typically 1 hour, withdrawn from the solution, washed with clean solvent, and dried with a stream of nitrogen gas. The presence of P1 on the electrode particulate surface was confirmed by its absorption spectrum. In this manner, the negative electrode was prepared.

### Assembly of Test Cell

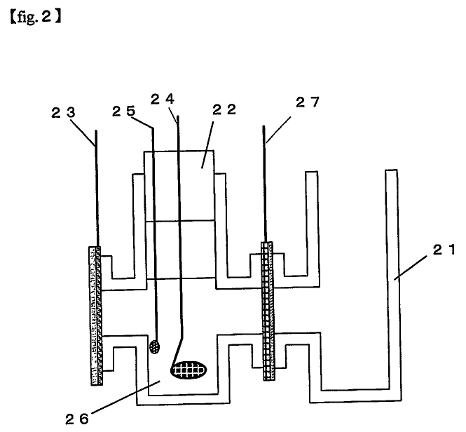

The negative electrode thus prepared was then used to assemble a power-generating cell 21 having the structure shown in FIG. 2.

In the power-generating cell 21, the film of particulate SnO₂ on the negative electrode 23 on which the dye P1 is deposited comes in contact with an electrolyte 26. In the electrolyte 26 are disposed a counter electrode 24 which forms a battery in combination with the negative electrode 23 and a reference electrode 25 which gives a reference potential on the basis of which the potential of the negative electrode 23 is measured. Further disposed is an air electrode 27, which forms a battery in combination with the negative electrode 23 instead of the counter electrode 24. The air electrode 27 was prepared by embedding a mixture of Mn₂O₃ powder, activated charcoal powder, acetylene black powder and polytetrafluoroethylene (PTFE) binder on a nickel screen having a thickness of 0.2 mm. The reference numeral 22 indicates a silicon plug for fixing the counter electrode 24 and the reference electrode 25 to the power-generating cell 21.

### Operating Characteristics of Photoelectric Power-Generating Cell

A power-generating cell (a) was assembled as described above, using the negative electrode 23, a platinum (Pt) counter electrode (24), and an electrolyte 26, which is a 0.1 M aqueous solution of sodium acetate (NaOAc) containing 2.5 mM hydroquinone (QH₂) as an oxidation-reduction mediator (R).

A power-generating cell (b) was assembled as described above, using the negative electrode 23, a platinum (Pt) counter electrode 24 immersed in a saturated aqueous solution of potassium sulfate free of dissolved oxygen and isolated from the electrolyte 26 by an ion-permeable membrane, and electrolyte 26, which is a 0.1 M aqueous solution of sodium acetate (NaOAc) containing 2.5 mM nicotinamide-adenine dinucleotide in the reduced form (NADH) as an oxidation-reduction mediator (R).

A power-generating cell (c) was assembled as described above, using the negative electrode 23, a counter electrode 24, which is a mercury/mercury (I) sulfate electrode separated from electrolyte 26 by an ion permeable membrane, and electrolyte 26, which is an 0.1 M aqueous solution of sodium acetate containing 2.5 mM nicotinamide-adenine dinucleotide in the reduced form (NADH) as an oxidation-reduction mediator (R).

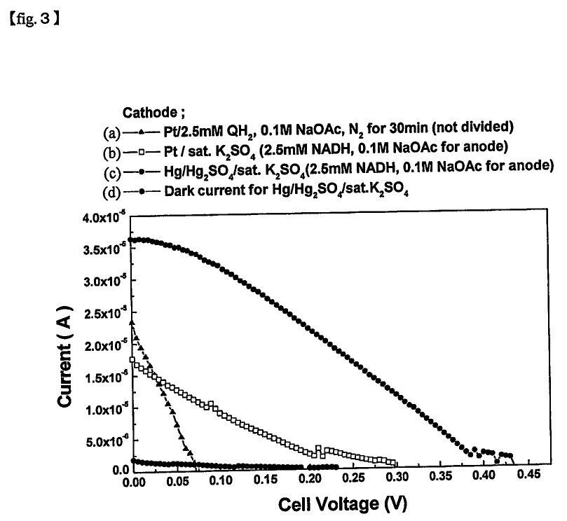

FIG. 3 illustrates current-voltage characteristics of these power-generating cells developed when they are irradiated with light having a wavelength of 520 nm. In FIG. 3, the curves (a), (b) and (c) indicate the current-voltage characteristics of the power-generating cells (a), (b) and (c), respectively. All the power-generating cells (a), (b) and (c) work as batteries, although they show differences in current-voltage characteristics. In FIG. 3, the curve (d) indicates the current-voltage characteristics of the power-generating cell (a) developed when it is not irradiated with light. When not irradiated with light, a power-generating cell gives little or no output current.

In these cells, the dye deposited on the negative electrode acts as a photosensitizer compound (S) which upon irradiation produces an excited state (S*). In contact with the metal oxide, it injects an electron into the oxide particle, producing an oxidant (S⁺). The external circuit removes the electron thus produced, where it is then measured as output current of the battery. In cells of type (c), the oxidant (S⁺) receives an electron from the oxidation-reduction mediator NADH (or in some cases QH₂), regenerating S. Thus, in a cell lacking enzymes or carbon-containing fuel compounds, the supply of electrons to the external circuit lasts until NADH (or QH₂ when that is used as the oxidation-reduction mediator) is consumed.

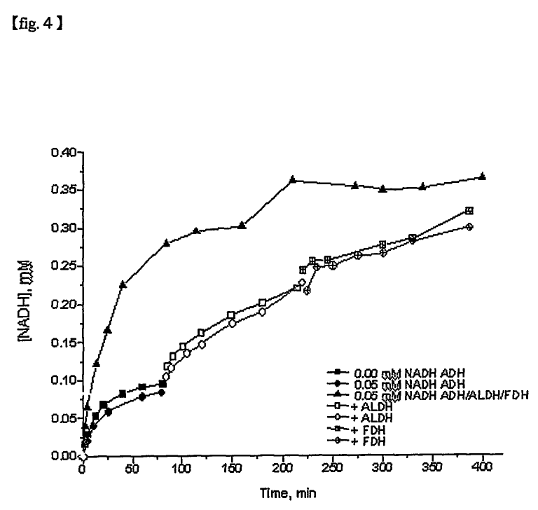

An assay (not performed in the cell) was done to test the production of NADH when NAD⁺ is present and methanol is used as the carbon-containing fuel compound. An aqueous solution of pH 8.0 containing 1 M NaCl, 5 mM oxidized nicotinamide-adenine-dinucleotide (NAD⁺) and methanol with 0.0 and 0.05 mM reduced nicotinamide-adenine-dinucleotide (NADH) and an alcohol dehydrogenase (ADH), an aldehyde dehydrogenase (ALDH) and a formate dehydrogenase (FDH) as enzymes added thereto. The change of NADH concentration with time during irradiation with light is shown in FIG. 4.

In FIG. 4, the symbol ▴ indicates the change of NADH concentration in a solution having 5.0 mM NAD⁺, 0.05 mM NADH, ADH, ALDH and FDH added thereto. The symbol ● indicates the change of NADH concentration in a solution having 5 mM NAD⁺, 0.05 mM NADH and ADH added thereto. The symbol ◯ indicates the change of NADH concentration in the same solution as in (●), but having ALDH added thereto after the lapse of a predetermined time from the addition of NADH and ADH. The symbol ◯+ indicates the change of NADH concentration in the solution (◯) but having FHD added thereto after the lapse of a predetermined time from the addition of NADH, ADH and ALDH. The symbol ▪ indicates the change of NADH concentration in the electrolyte having 5 mM NAD⁺ and ADH added thereto. The symbol □ indicates the change of NADH in the same solution as the solution ▪ but having ALDH added thereto. The symbol □+ indicates the change of NADH in the same solution as the electrolyte □ but having FDH added thereto. All these tests were observed to have an increase of NADH concentration, demonstrating that an electron moves from methanol to NAD⁺ through the mediation of the enzyme to produce NADH. In other words, as shown in FIG. 4, NADH is formed from NAD⁺ through the mediation of enzymes that utilize methanol. These results imply that as long as methanol is present in a power-generation cell with the mediation of enzymes, NADH used by the negative electrode will be regenerated, and power generation can be maintained under irradiation with light.

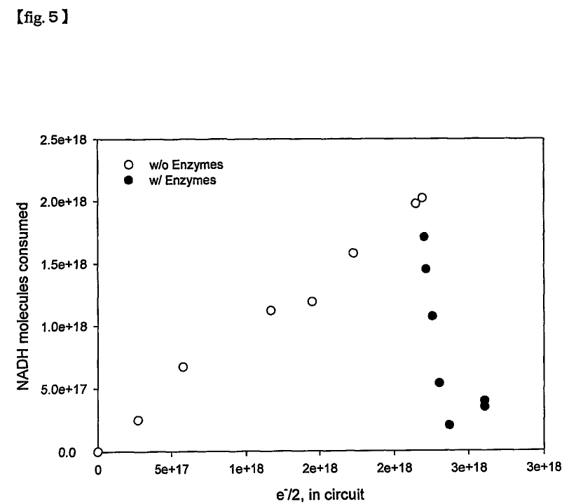

FIG. 5 is a graph illustrating the relationship between the amount of electrons taken out of the cell by the external circuit (abscissa) and the amount of NADH consumed by irradiation with light (ordinate) in a power-generating cell of type (c), with the electrolyte 26 containing NADH and methanol. The symbol ◯ indicates the relationship between the amount of NADH consumed and the amount of electrons produced in the external circuit when the electrolyte is free of enzymes. This relationship shows that the consumed amount of NADH and the amount of electrons are proportional to each other, demonstrating that electrons released from NADH are properly taken out by the external circuit. The symbol ● indicates the relationship between the amount of NADH consumed and the amount of electrons produced in the external circuit when ADH, ALDH and FDH are added to the electrolyte as the enzyme system. Under these conditions, little or no NADH is consumed, regardless of the amount of electrons removed by the external circuit. In other words, NADH releases electrons to form NAD⁺, which then receives electrons from methanol through the mediation of the enzymes thus added to regenerate NADH. This state of little or no NADH consumption lasts as long as methanol is present in the electrolyte. In other words, power generation continues while methanol is present.

In these and other experiments, the concentration of NADH in the electrolyte was determined by the intensity of the peak present in the vicinity of 340 nm in the UV absorption spectrum of NADH.

In the present example, tin oxide (SnO₂) was used as the oxide semiconductor. The same evaluation was made with particulate TiO₂, and could be made with films of particulate metal oxide such as ZnO and TiO₂.WO₃ instead of SnO₂. The same evaluation using SnO₂ was also made on the compounds P2, P3, P4, P5 and P6 instead of the compound P1 as a photosensitizer. These compounds also produce an oxidant and an electron when irradiated with light. As a result, these power-generating cells will exhibit operating characteristics similar to that of P1.

### EXAMPLE 2

A power-generating cell was formed by the same type of negative electrode 23 as used in Example 1, platinum (Pt) as counter electrode 24 and an aqueous buffered solution at pH 8.0 containing NADP⁺/NADPH as the oxidation-reduction mediator in the electrolyte. D-Glucose-6-phosphate (G-6-P) was used as a carbon-containing fuel compound. D-glucose-6-phosphate dehydrogenase (G-6-PDH) and 6-phosphogluconate dehydrogenase (6-PGDH) were used as an enzyme system.

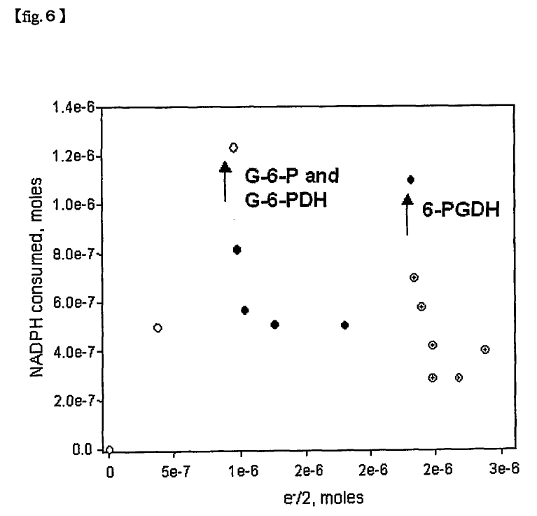

FIG. 6 is a graph illustrating the relationship between the amount of electrons removed by the external circuit from the electrolyte (abscissa) and the amount of NADPH consumed during irradiation with light (ordinate). The symbol ◯ indicates the relationship between the amount of NADPH consumed and the amount of electrons injected into the external circuit with an the electrolyte free of fuel and enzyme. This relationship shows that the amount of NADPH consumed and the amount of electrons produced are proportional to one another, demonstrating that electrons released from NADPH are removed by the external circuit. The symbol ● indicates the relationship between the amount of NADPH consumed and the amount of electrons removed in the electrolyte to which has been added G-6-P as a carbon-containing fuel compound, and the enzyme G-6-PDH. The amount of NADPH consumed is greatly reduced. This result shows that NADPH has released electrons to form NADP⁺, which then receives electrons from G-6-P to regenerate NADPH through the mediation of the added enzymes. The amount of NADPH consumed remains approximately constant regardless of the number of electrons removed by the external circuit. This state lasts as long as G-6-P is present in the electrolyte. At later times, when G-6-P is entirely oxidized to gluconolactone-6-phosphate, the amount of NADPH consumed again rises. The gluconolactone-6-phosphate hydrolyzes in the electrolyte to 6-phosphogluconate (6-PG). The amount of NADPH consumed increases in proportion to the amount of electrons removed into the external circuit. When 6-PGDH, which is an enzyme that oxidizes 6-PG, is added to the electrolyte, the amount of NADPH consumed shows a sudden drop as shown by the symbol ◯+ in FIG. 6. Electrons are again supplied by 6-PG, which is a fuel, to regenerate NADPH. The reception of electrons by the external circuit lasts as long as 6-PG is present in the electrolyte.

In this example, the oxide semiconductor was tin oxide (SnO₂). Similar evaluations could be made on films of particulate TiO₂ or other particulate metal oxides such as ZnO and TiO₂.WO₃.

### EXAMPLE 3

A power-generating cell was formed by the same negative electrode 23 as used in Example 1, platinum (Pt) as a counter electrode 24 and a buffered solution at pH 8.0 containing a 0.5 mM NADH and 10 mM NAD⁺ as an electrolyte. Ethanol (CH₃CH₂OH) was used as a carbon-containing fuel compound. The nicotinamide-adenine-dinucleotide couple (NADH)/(NAD⁺) was used as the oxidation-reduction mediator. An alcohol dehydrogenase (ADH) and an aldehyde dehydrogenase (ALDH) were used as an enzyme system.

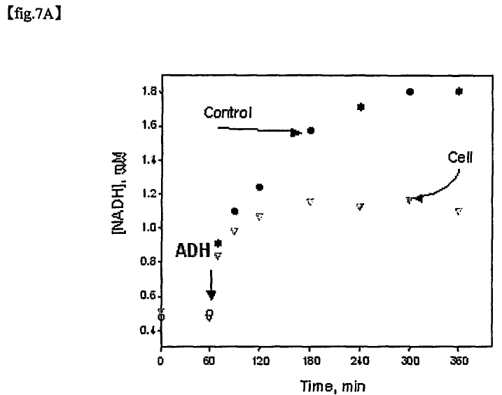

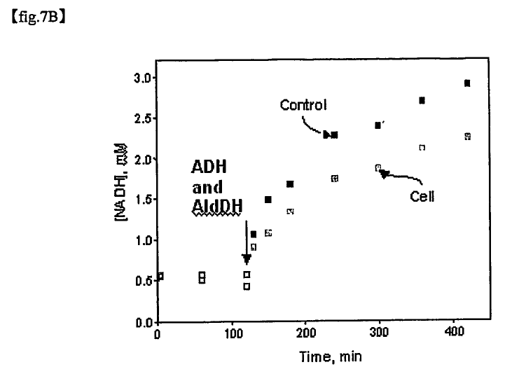

FIG. 7A is a graph illustrating the change of NADH concentration with time in the electrolyte containing ethanol. An alcohol dehydrogenase (ADH) enzyme system was added thereto after 60 minutes. In FIG. 7A, the symbol ▾ indicates the change of NADH concentration in the power-generating cell containing ethanol and ADH. The concentration of NADH increases with light irradiation time until it reaches a value determined by the amount of electrons removed by the external circuit and the amount of ethanol in the electrolyte. On the contrary, the symbol ● indicates the change of NADH concentration in an identical electrolyte put in a container free of electrodes, but having ADH added thereto under the same conditions as in the power-generating cell. In FIG. 7A, these data are noted as “Control”. Since the Control has no electrodes, electrons are not removed by the external circuit. The NAD⁺ in the electrolyte receives electrons from ethanol and is converted to NADH through the mediation of ADH. Thus, the concentration of NADH continues to increase with time.

A power-generating cell was formed by a negative electrode 23, an air electrode 27 and an electrolyte at pH 8 containing ethanol, NADH and ADH as an enzyme system. When irradiated with sunlight, the power-generating cell operated as a photobiological fuel cell having a voltage of about 0.65 V.

FIG. 7B is a graph illustrating the change of NADH concentration with time in the electrolyte containing ethanol with later addition of an alcohol dehydrogenase (ADH) and aldehyde dehydrogenase (ALDH) as an enzyme system.

In FIG. 7B, the gray empty squares indicate the NADH concentration in the power-generating cell after addition of ethanol, but prior to addition of ADH and ALDH. The NADH concentration is constant. After addition of ADH and ALDH (gray filled squares), the concentration of NADH increases until it approaches a value determined by the amount of electrons taken out by the external circuit and the amount of ethanol and its oxidation product acetaldehyde in the electrolyte. The black empty squares indicate the change of NADH concentration in an electrolyte with ethanol, put in a container free of electrodes, prior to addition of enzymes. The concentration is constant. After addition of ADH and ALDH under the same conditions as in the power-generating cell, the rise in NADH concentration is shown as black filled squares. In FIG. 7B, these latter plots are identified as “Control”. Since Control has no electrodes, electrons are not removed by the external circuit. NAD⁺ in the electrolyte receives electrons from ethanol and acetaldehyde, and is converted to NADH through the mediation of ADH and ALDH. Thus, the concentration of NADH continues to increase with time.

A power-generating cell was formed by an electrolyte 23, an air electrode 27, and an electrolyte containing NADH, NAD⁺, ethanol, and ADH and ALDH as an enzyme system. When irradiated with sunlight, the power-generating cell operated as a photobiological fuel cell having a voltage of about 0.65 V.

In the present example, tin oxide (SnO₂) was used as the oxide semiconductor. The same evaluation could be made with films of particulate TiO₂, or other particulate metal oxides such as ZnO and TiO₂.WO₃ instead of SnO₂. The same evaluation could also be made on the compounds P2, P3, P4, P5 and P6 instead of the compound P1 as a photosensitizer compound, which produces an oxidant and an electron when irradiated with light.

### EXAMPLE 4

A power-generating cell was formed by the same negative electrode 23 as used in Example 1, platinum (Pt) as a counter electrode 24 and a buffer solution having pH 7.3 containing an NAD⁺/NADH oxidation-reduction mediator in the electrolyte. D-glucose was used as a carbon-containing compound was used. D-glucose-dehydrogenase (GDH) was used as an enzyme.

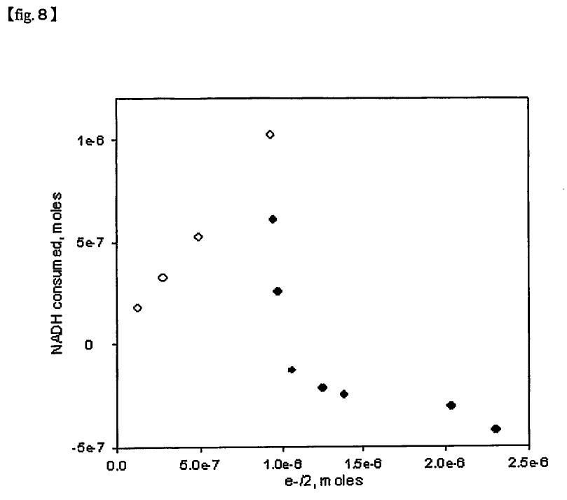

FIG. 8 is a graph illustrating the relationship between the amount of electrons removed by the external circuit from the electrolyte having GDH added thereto as an enzyme system (abscissa) and the amount of NADH consumed during irradiation with light (ordinate). The symbol ◯ indicates the relationship between the amount of NADH consumed and the amount of electrons produced prior to addition of the enzyme, but with D-glucose present. This relationship shows that the amount of NADH consumed and the amount of electrons are proportional to one another, demonstrating that electrons released from NADH are removed by the external circuit. The symbol ● indicates the relationship between the amount of NADH consumed and the amount of electrons produced in the external circuit from the electrolyte after addition of the enzyme system.

Before addition of the enzyme, NADH is consumed and oxidized to NAD⁺, with the concurrent production of electrons in the external circuit. After addition of the enzyme, NADH is regenerated and the amount apparently consumed drops slightly below the original amount. In other words, NADH releases electrons to form NAD⁺, which then receives electrons from D-glucose through catalysis by the enzyme to reform NADH. Thus, in the presence of the enzyme, the amount of NADH consumed is kept constant regardless of the number of electrons thus taken out. This state lasts as long as D-glucose is present in the electrolyte.

In the present example, tin oxide (SnO₂) was used as the oxide semiconductor. The same evaluation could be made on films of particulate TiO₂, and on other particulate metal oxides such as ZnO and TiO₂.WO₃, instead of SnO₂. The same evaluation could also be made on the compounds P2, P3, P4, P5 and P6 instead of the compound P1 as a photosensitizer compound which produces an oxidant and an electron when irradiated with light.

As mentioned above, the invention provides a photobiological fuel cell, which carries out an oxidation reaction involving the electrochemical reception of electrons from a carbon-containing fuel compound by an external electric circuit, via a photosensitizer molecule optically excited at the negative electrode and suitable electron mediators, to generate an electromotive force across the positive electrode and the negative electrode. In accordance with the invention, chemical energy possessed by the carbon-containing compound can be effectively utilized as electrical energy.

While the invention has been described in detail and with reference to specific embodiments thereof, it will be apparent to one skilled in the art that various changes and modifications can be made thereto without departing from the spirit and scope thereof.

1. A photobiological fuel cell comprising a positive electrode and a negative electrode provided with an electrolyte interposed between them, wherein the reactions of and concerning the negative electrode comprise:
(1) a process that comprises irradiation with light to produce an excited state of a photosensitizer, which provides an electron and an oxidized form of the photosensitizer;
(2) a process that comprises supplying an electron to the oxidized photosensitizer from a reduced form of an oxidation-reduction mediator; and
(3) a process which comprises one or more oxidation reactions of carbon-containing compounds catalyzed by one or more enzymes to provide electrons to an oxidized form of said oxidation-reduction mediator, whereby the reaction of the carbon containing compound as a fuel causes the supply of electric power to an external electric circuit.

2-12. (canceled)
